(19) United States
(12) Patent Application Publication
(10) Pub. No.: US 2023/0214940 A1
(43) Pub. Date: Jul. 6, 2023

(54) STAFFING PLATFORM WITH OPPORTUNISTIC UTILIZATION OF REGIONAL LABOR BURDEN DIFFERENCES

(71) Applicant: Gig Forces, Inc. DBA onDiem, Portland, OR (US)

(72) Inventor: Joe Fogg, Portland, OR (US)

(21) Appl. No.: 18/148,972

(22) Filed: Dec. 30, 2022

Related U.S. Application Data
(60) Provisional application No. 63/266,188, filed on Dec. 30, 2021.

(51) Int. Cl. G06Q 40/12; G06Q 10/0631; G06Q 10/1053

(52) U.S. Cl. CPC G06Q 40/123; G06Q 10/063116; G06Q 10/06315; G06Q 10/1053

(57) ABSTRACT

The computerized staffing platform includes a staffing server with a processor configured to store data indicating available shifts from third-party businesses and data indicating employees of the platform registered to fulfill the available shifts. The processor is configured to receive a request from a particular business to fulfill a target available shift, and determine candidate employees to fulfill the target available shift. The processor is configured to compute a predicted labor burden associated with hiring each candidate employee for the target available shift, including whether the candidate employee has exceeded an income threshold after which a labor burden factor no longer applies. The processor is further configured to send, to the particular business, a list of the candidate employees and the predicted labor burden for each candidate employee, receive a selection of a candidate employee, and send, to the selected candidate employee, an offer to fulfill the available target shift.

### CROSS REFERENCE TO RELATED APPLICATIONS

This application claims priority to U.S. Provisional Patent Application Ser. No. 63/266,188, filed Dec. 30, 2021 and titled STAFFING PLATFORM WITH OPPORTUNISTIC UTILIZATION OF REGIONAL LABOR BURDEN DIFFERENCES, the entirety of which is hereby incorporated herein by reference for all purposes.

### BACKGROUND

Employers are required to pay taxes for each employee, such as those imposed by the Federal Unemployment Tax Act (FUTA) and the State Unemployment Tax Act (SUTA) in the United States. When workers are employed regularly with a single employer, these taxes are easily calculated and included in the labor burden for each worker. However, in recent years, it has become more common for workers to work at multiple job locations, for multiple employers, and for irregular time periods. FUTA and SUTA taxes are only required to be paid for an employee until they have achieved a predetermined taxable wage base. Additionally, SUTA tax rates and taxable wages bases are set by each state. Similarly complicated tax situations exist for workers who work for multiple employers in multiple locations in other countries that impose such taxes on a national, regional, and local level. Therefore, a challenge exists in determining the actual labor burden of a worker who works for multiple employers in these types of tax regimes.

### SUMMARY

A computerized staffing platform is provided. The computerized staffing platform comprises a staffing server including a processor and associated memory. The processor is configured to execute instructions using the memory to store data indicating a plurality of available shifts from a plurality of third-party businesses, and store data indicating a plurality of employees of the computerized staffing platform who are registered to fulfill available shifts listed on the server. The processor is further configured to receive, from a particular business of the plurality of third-party businesses, a request to fulfill a target available shift, and determine, from the plurality of employees, one or more candidate employees for the target available shift. For each candidate employee, the processor is configured to compute a predicted labor burden associated with hiring the candidate employee for the target available shift. The predicted labor burden accounts for whether the candidate employee has exceeded an income threshold after which a labor burden factor no longer applies. The predicted labor burden is based on earned income data recorded for the candidate employee for one or more shifts fulfilled with at least one third-party business on the computerized staffing platform. The processor is further configured to send, to the particular business, a list of the candidate employees, including an indication of the predicted labor burden for each candidate employee, and receive, from the selected candidate employee, an indication of whether they agree to fulfill the target available shift.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a computerized staffing platform.

FIG. 2 illustrates a request from a third-party business to fulfill a target available shift via the computerized staffing platform of FIG. 1.

FIG. 3 is an example table of tax rates for predicting a labor burden for employees of the computerized staffing platform of FIG. 1.

FIGS. 4A-4C illustrate example earned income data for three candidate employees of the computerized staffing platform of FIG. 1 for predicting a respective labor burden.

FIGS. 5A-5C illustrate example predicted labor burdens for three candidate employees of the computerized staffing platform of FIG. 1.

FIG. 6 illustrates an offer to a candidate employee to fulfill the target available shift via the computerized staffing platform of FIG. 1.

FIG. 7 shows a flowchart for a computerized staffing platform method.

FIG. 8 is an example computing system according to an embodiment of the present description.

### DETAILED DESCRIPTION

Labor burden is the cost an employer incurs, in addition to wages or salary, to employ its workers. Labor burden includes payroll taxes, retirement benefits, health benefits, worker's compensation, life insurance, pensions, and other fringe benefits. Payroll taxes include taxes imposed at the national and regional levels, such as the Federal Unemployment Tax Act (FUTA) and the State Unemployment Tax Act (SUTA), which fund federal and state unemployment programs in the United States, respectively. FUTA tax is paid to the federal government, and SUTA tax is paid to the state in which an employee works. FUTA and SUTA taxes are both based on a percentage of the employee's earnings. However, while FUTA tax rates are standardized across all states, SUTA tax rates may vary by state. Additionally, FUTA and SUTA taxes are only required to be paid until the employee has earned a predetermined amount, i.e., wage base. Like the tax rates, the FUTA wage base is standardized across all states while the SUTA wage base may vary from state to state. When an employee works for a single employer in one state, these taxes are relatively simple to calculate. However, when an employee works for different employers, such as a temporary or “gig” worker hired through a staffing platform, it can be challenging to correctly calculate the labor burden of an employee with regard to whether the FUTA and/or SUTA wages bases have been achieved. This challenge is compounded for employers who manage several employees who each work in multiple states, as the states may have different SUTA tax rates, different wage base requirements, and different multiplication factors for determining worker's compensation amounts. Similar challenges exist in countries outside the United States, with national, regional, and local tax regimes that complicate the taxation of wages of workers who work for multiple employers in multiple locations.

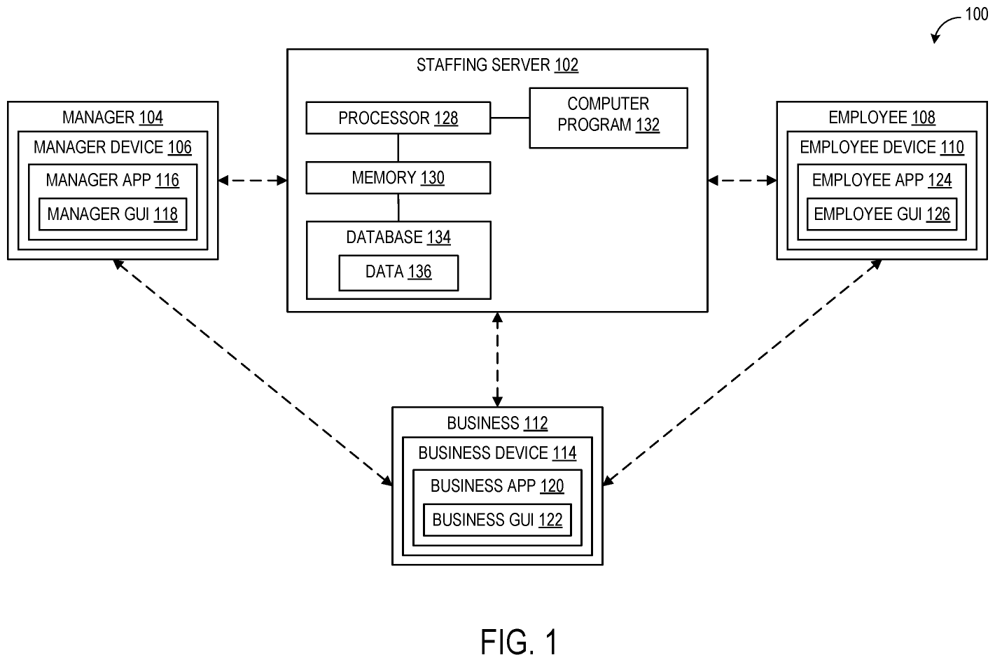

To address the issues discussed above, as shown in FIG. 1, a computerized staffing platform 100 is provided. The computerized staffing platform 100 includes a staffing server 102 in communication with a manager 104 via a manager device 106, at least one employee 108 via an employee device 110, and at least one third-party business 112 via a business device 114.

A manager application 116 including a manager graphical user interface (GUI) 118 is executable on the manager device 106 to facilitate the fulfillment of available shifts from one or more third-party businesses 112 with employees 108 registered with the computerized staffing platform 100. Third-party businesses 112 can request fulfillment of a target available shift and select a candidate employee 108A for the target available shift via a business application 120 including a business graphical user interface (GUI) 122 that is executable on the business device 108. Similarly, employees 108 registered with the computerized staffing platform 100 can update personal information (e.g., availability and desired pay rate), submit queries for available shifts, and accept offers to fulfill a target available shift via an employee application 124 including an employee graphical user interface (GUI) 126 that is executable on the employee device 106.

The staffing server 102 includes a processor 128 and associated memory 130. The processor 128 is configured to executed instructions included in a computer program 132 using the memory 130. The staffing server 102 further includes a database 134 configured to store data 136 for the computerized staffing platform 100. The stored data 136 indicates a plurality of available shifts from a plurality of third-party businesses 112, as well as a plurality of employees 108 of the computerized staffing platform 100 who are registered to fulfill available shifts listed on the staffing server 102.

Features of the computerized staffing platform 100 allow a third-party business 112 to fulfill available shifts with employees 108 in a complex work environment including multiple work sites and regions, varying rates of pay, and with employees 108 having differences in predicted labor burdens. A detailed description of the computerized staffing platform 100 follows.

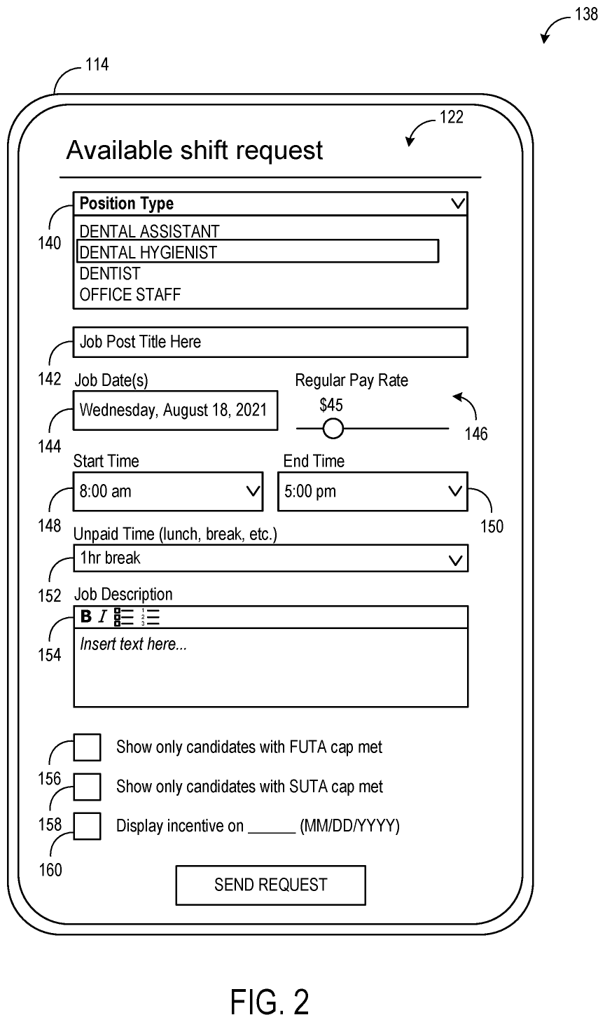

The computerized staffing platform 100 is configured to receive requests to fulfill target available shifts from a plurality of third-party businesses 112, which are added to the plurality of available shifts in the stored data 136. Turning now to FIG. 2, an example of a shift request 138 from a particular business 112A of the plurality of third-party businesses 112 to fulfill a target available shift via the computerized staffing platform 100 is shown. While the target available shift is with a dental practice in this example, it will be appreciated that the computerized staffing platform 10 may be implemented for fulfilling available shifts in many types of businesses having more than one employee.

As described above, the request 138 may be submitted to the computerized staffing platform 100 via the business GUI 122 for the business application 120 that is executable on the business device 114. The request 138 includes several fields such as a position type menu 140 that lists selectable position types of employees with the dental practice. Other fields include a job post title field 142, job date 144, regular pay rate 146, start time 148, end time 150, unpaid time 152, and job description field 154. All fields are editable and can be saved with the computerized staffing platform 100 for future job posts.

As described above, the labor burden of an employee includes payroll taxes, such as FUTA and SUTA taxes, that are based on a percentage of the employee's earnings. However, FUTA and SUTA taxes are only required to be paid until the employee has earned a predetermined amount, i.e., wage base. As such, the labor burden of an employee is reduced when the employee's wage base satisfies one or both of the FUTA and SUTA taxes amounts. To be matched with employees 108 that have a reduced labor burden, the particular business 112A may select options 156, 158 to filter the request to return only candidate employees 108A whose FUTA and/or SUTA caps have been met, and thus FUTA and/or SUTA taxes, respectively, do not apply. Additionally, as described in detail below, the particular business 112A may select an option 160 to indicate an employee incentive to candidate employees 108A based on a condition that at least one of FUTA and SUTA taxes do not apply. The incentive may be displayed for the duration the shift request 138; alternatively, the particular business 112A may choose to being displaying the incentive on a certain date, such as if the target available shift remains unfulfilled for a predetermined amount of time, for example.

Upon receiving the request 138 from the particular business 112A, the computerized staffing platform 100 is configured to determine, from the plurality of employees 108, one or more candidate employees 108A for the target available shift. In determining the candidate employees 108A, the computerized staffing platform 100 may compute a predicted labor burden associated with hiring each candidate employee 108A for the target available shift.

The predicted labor burden for each candidate employee 108A is computed at least in part by determining the amounts of FUTA and SUTA tax that are required to be paid for the candidate employee 108A for the target available shift. This computation is based on earned income data recorded for one or more shifts fulfilled with at least one third-party business 112 on the computerized staffing platform 100, and takes into account whether each candidate employee 108A has exceeded an earned income threshold after which a labor burden factor no longer applies. The labor burden factor is at least one of a first tax rate, i.e. FUTA tax rate, and a second tax rate, i.e., SUTA tax rate. With reference to FIG. 1, the data 136 stored in the database 134 further includes employee information with regard to the amount of FUTA tax and the amount of SUTA tax that have been paid for each employee 108 of the plurality of employees of the computerized staffing platform 100.

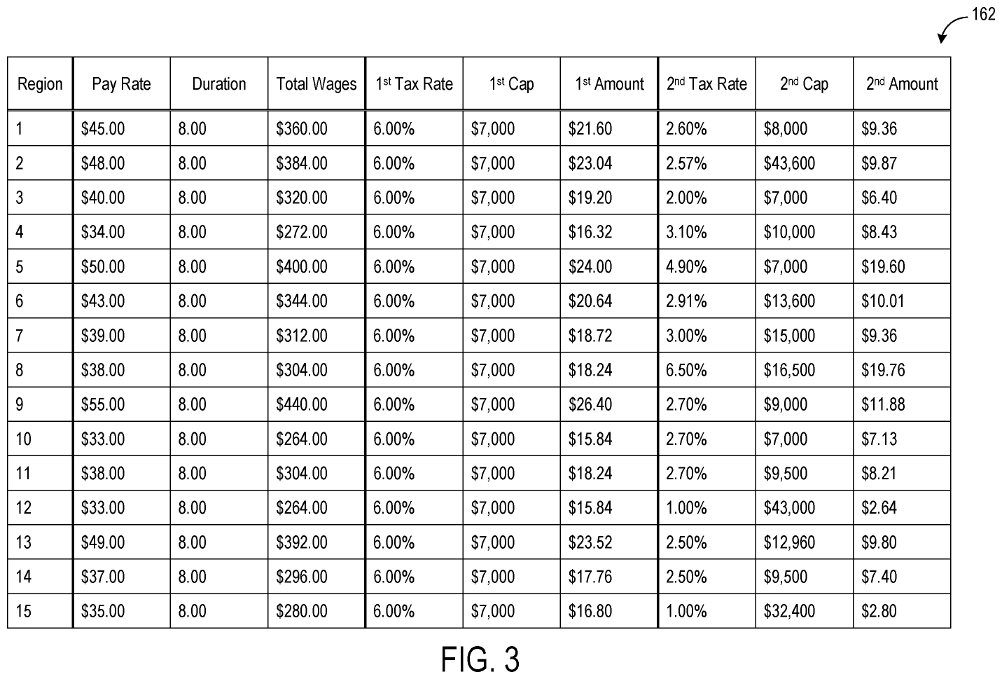

FIG. 3 is an example table 162 of FUTA and SUTA tax rates for predicting a labor burden for employees of the computerized staffing platform of FIG. 1. The table shows a pay rate for each of 15 regions (i.e., states), as well as the total wages for a shift having 8 paid hours in the respective state. The first (i.e., FUTA) tax rate, the amount of FUTA tax to pay, the second (i.e., SUTA) tax rate, and the amount of SUTA tax to pay are shown for each state with regard to the total wages for the shift. The first and second caps (i.e., first and second earned income thresholds) are also listed for each state. As shown, while the FUTA tax rate and the first earned income threshold for the FUTA tax are the same for each state, the SUTA tax rate and the second earned income threshold for the SUTA tax may vary greatly from state to state.

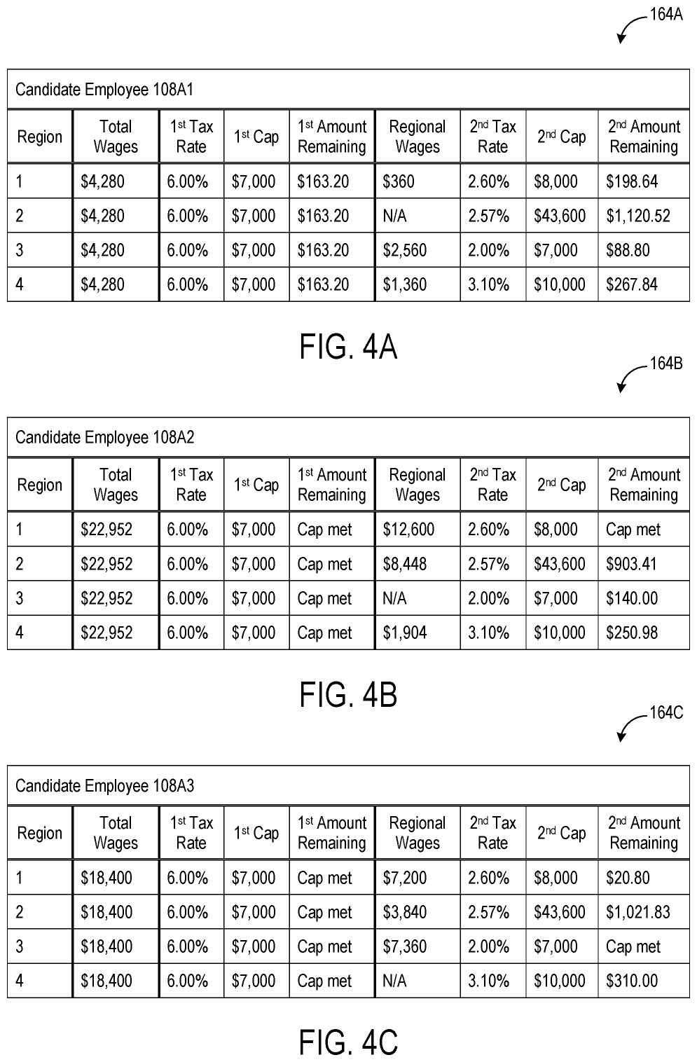

FIGS. 4A-4C shown example earned income data 164A, 164B, 164C for three candidate employees 108A1, 108A2, 108A3 of the computerized staffing platform 100 for predicting a respective labor burden. For the sake of clarity, determining the amounts of FUTA tax and SUTA tax to be paid is described below with reference to the earned income data 164A for the first candidate employee 108A1, as shown in FIG. 4A. However, it will be appreciated that the amounts of FUTA tax and SUTA tax can be similarly determined for candidate employees 108A2 and 108A3.

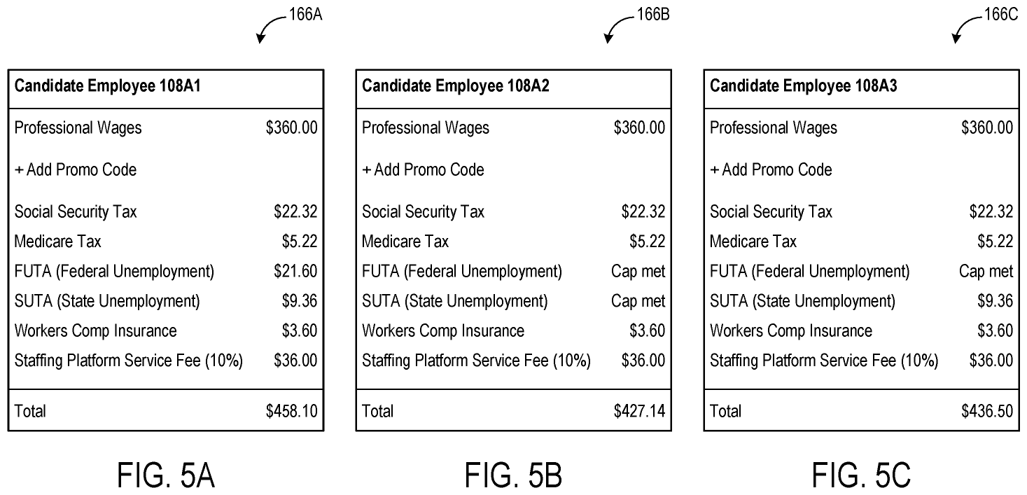

To determine the amount of FUTA tax to pay, a first amount of gross income earned by the candidate employee 108A is estimated. The first amount of gross income is earned during one or more shifts fulfilled with at least one third-party business 112 on the computerized staffing platform 100 in a plurality of states. In the example shown in FIG. 4A, the candidate employee 108A1 completed shifts for third-party businesses 112 through the computerized staffing platform in the Regions 1, 3, and 4, earning, $360, $2,560, and $1,360, in each respective region. The first amount of gross income is a combined amount of income earned in all three regions, i.e., $4,280. Next, a FUTA tax rate and a predetermined first earned income threshold, i.e. first cap, above which the FUTA tax does not apply are determined. In the example shown in FIG. 4A, the FUTA tax rate is 6.00%, and the first earned income threshold is $7,000. As the total wages of $4,280 fall below the first cap, it can be calculated that FUTA tax in the amount of $163.20 remains to be paid. With this information, an amount of FUTA tax to be paid for the target available shift can be calculated, based on the FUTA tax rate, a pay rate for the target available shift, and a duration of the target available shift, as discussed below with reference to FIGS. 5A-5C.

To determine the amount of SUTA tax to pay, a second amount of gross income earned by the candidate employee 108A is estimated. The second amount of gross income is earned during one or more shifts fulfilled with at least one third-party business 112 on the computerized staffing platform 100 in a particular state in which the target candidate shift is located. In the example shown in FIG. 4A, if the target candidate shift is in Region 1, the second amount of gross income would be the amount of income earned by the candidate employee 108A1 in Region 1, i.e., $360. Next, a SUTA tax rate and a predetermined second earned income threshold, i.e., second cap, above which the SUTA tax does not apply are determined. In the example shown in FIG. 4A, the SUTA tax rate for Region 1 is 2.60%, and the second earned income threshold is $8,000. As the wages earned in Region 1 fall below the second cap, it can be calculated that SUTA tax in the amount of $198.64 remains to be paid. With this information, an amount of SUTA tax to be paid for the target available shift can be calculated, based on the SUTA tax rate, a pay rate for the target available shift, and a duration of the target available shift, as discussed below with reference to FIGS. 5A-5C.

Example predicted labor burdens 166A, 166B, 166C for the target available shift in Region 1 are shown in FIGS. 5A-5C. The example predicted labor burdens 166A, 166B, 166C correspond to the example earned income data 164A, 164B, 164C for three candidate employees 108A1, 108A2, 108A3 shown in FIGS. 4A-4C. As indicated above with reference to FIGS. 2 and 3, the professional wages for the target available position are $360 for 8 hours of pay at $45 per hour.

With reference to FIG. 4A, candidate employee 108A1 has earned $4,280 in total wages while fulfilling shifts through the computerized staffing platform 100, with $360 earned in Region 1. The candidate employee 108A1 has not met either the FUTA cap nor the SUTA cap, and FUTA and SUTA taxes are included in the predicted labor burden 166A for this candidate employee. Again referring to FIGS. 3 and 4A, the FUTA tax rate is 6.00%, and the SUTA tax rate in Region 1 is 2.60%. As such, for the target available shift for candidate employee 108A1, the amount of FUTA tax to be paid is $21.60, and the amount of SUTA tax to be paid is $9.36.

With reference to FIG. 4B, candidate employee 108A2 has earned $22,952 in total wages while fulfilling shifts through the computerized staffing platform 100, with $12,600 earned in Region 1. The candidate employee 108A2 has met both the FUTA cap and the SUTA cap, and the predicted labor burden 166B for this candidate employee is reduced in comparison to the labor burden 166A for candidate employee 108A1.

With reference to FIG. 4C, candidate employee 108A3 has earned $18,400 in total wages while fulfilling shifts through the computerized staffing platform 100, with $7,200 earned in Region 1. The candidate employee 108A3 has met the FUTA cap but has not met the SUTA cap, and SUTA taxes are included in the predicted labor burden 166C for this candidate employee. Again referring to FIGS. 3 and 4C, the SUTA tax rate in Region 1 is 2.60%. As such, for the target available shift for candidate employee 108A3, the amount of SUTA tax to be paid is $9.36. The labor burden 166C for this candidate employee is reduced in comparison to the labor burden 166A for candidate employee 108A1, but is greater than the labor burden 166B for candidate employee 108A2. When the labor burden of the candidate employee 108A is reduced, the computerized staffing platform 100 may reduce the cost of the candidate employee 108A selected by the particular business 112A for the target available shift.

As described above, upon receiving the request 138 from the particular business 112A, the computerized staffing platform 100 determines one or more candidate employees 108A for the target available shift, and computes a predicted labor burden associated with hiring each candidate employee 108A for the target available shift. The computerized staffing platform 100 is configured to send, to the particular business 112A, a list of the candidate employees 108A, including an indication of the predicted labor burden for each candidate employee 108A, such as the example predicted labor burdens 166A, 166B, 166C. Upon receiving a selection of one of the candidate employees 108A from the particular business 112A, the computerized staffing platform 100 is configured to send, to the selected candidate employee 108A, an offer to fulfill the target available shift.

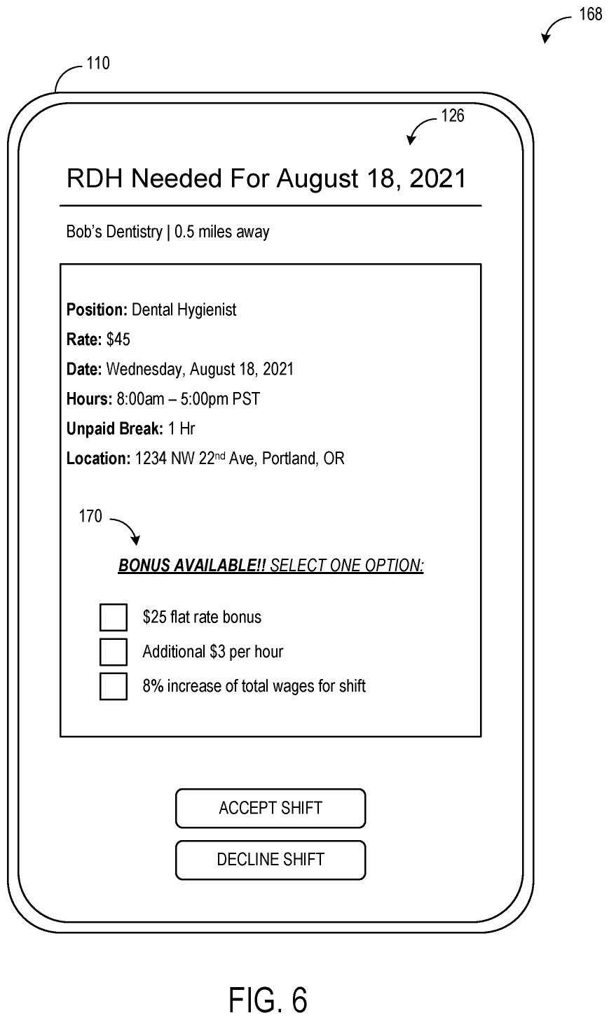

An example of an offer 168 to the selected candidate employee 108A is shown in FIG. 6. As illustrated, the offer 168 may be received through the employee application 124 on the employee device 110 and displayed via the employee GUI 126. The offer 168 confirms the date, name of the particular business 112A, position title, rate of pay, hours, any unpaid break time, and the address of the particular business 112A for the target available shift.

As described above, when the labor burden of the candidate employee 108A is reduced, the computerized staffing platform 100 may reduce the cost of the candidate employee 108A selected by the particular business 112A for the target available shift. In turn, as described with reference to FIG. 2, the particular business 112A may offer an incentive 160 to the candidate employee 108A for the target available shift, such as an increased pay rate, for example, based on the reduced cost of the candidate employee to the particular business. Additionally or alternatively, the computerized staffing platform 100 may be configured to compute a monetary reward based on the reduced labor burden and display the monetary reward to the candidate employee 108A in the offer 168. The incentive and/or the monetary reward may be displayed to the candidate employee as a bonus 170 included in the offer. As shown in FIG. 6, the bonus 170 may be a one-time bonus, an increased pay rate, and/or a percentage increase of total wages for the target available shift.

The computerized staffing platform 100 receives an indication of whether the selected candidate employee 108A agrees to fulfill the target available shift. If the selected candidate employee 108A accepts the shift, the particular business 112A is notified, and the target available position is considered fulfilled. If the selected candidate employee 108A actively declines or passively does not accept the shift within a predetermined time-frame, the particular business 112A is notified. The particular business 112A may select a different candidate employee 108A from the list of candidate employees, or they may request new or additional candidate employees to be matched with the target available shift.

In some implementations, the computerized staffing platform 100 may receive a query for available shifts from a particular employee of the plurality of employees 108. In response, the computerized staffing platform 100 may consider submitted shift requests to determine one or more candidate shifts for the particular employee's query from the plurality of available shifts, and send the candidate shifts to the particular employee as offers similar to offer 168 shown in FIG. 6. As with offer 168, the indication 170 of an employee incentive for each candidate shift based upon the particular employee's predicted labor burden 166 for the respective candidate shift is displayed.

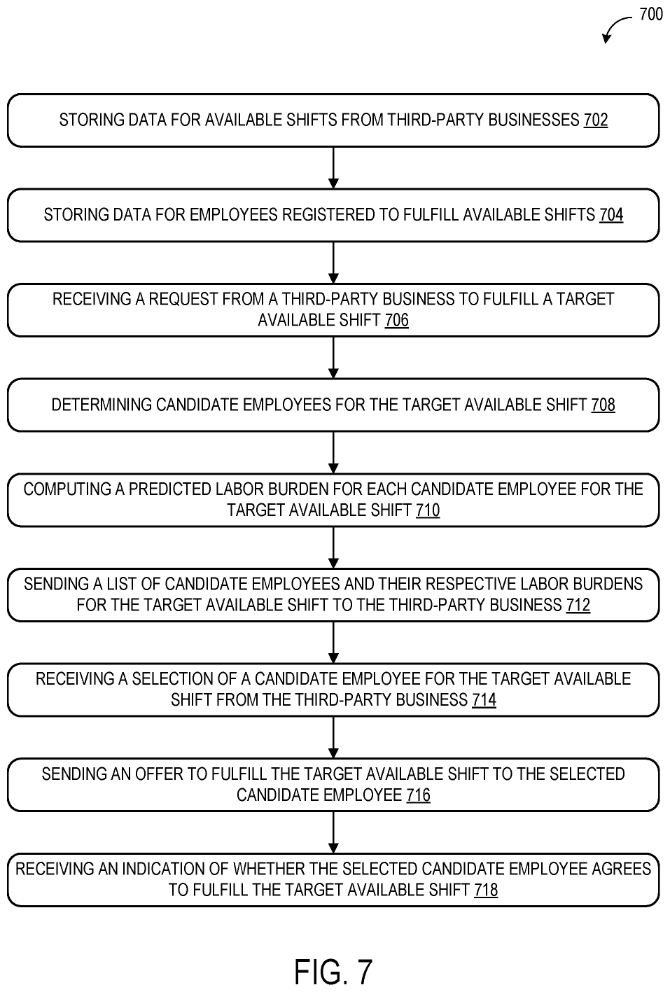

FIG. 7 shows a flow chart of a computerized staffing platform method 700 for matching a candidate employee to a target available shift of a particular third-party business on a computerized staffing platform. At step 702, the method 700 may include storing data indicating a plurality of available shifts from a plurality of third-party businesses. At step 704, the method 700 may include storing data indicating a plurality of employees of the computerized staffing platform who are registered to fulfill available shifts listed on the server. At step 706, the method 700 may include receiving, from a particular business of the plurality of third-party businesses, a request to fulfill a target available shift. At step 708, the method 700 may include determining, from the plurality of employees, one or more candidate employees for the target available shift. At step 710, the method 700 may include, for each candidate employee, computing a predicted labor burden associated with hiring the candidate employee for the target available shift. The predicted labor burden may account for whether the candidate employee has exceeded an income threshold after which a labor burden factor no longer applies, based on earned income data recorded for the candidate employee for one or more shifts fulfilled with at least one third-party business on the computerized staffing platform. At step 712, the method 700 may include sending, to the particular business, a list of the candidate employees, including an indication of the predicted labor burden for each candidate employee. At step 714, the method 700 may include receiving, from the particular business, a selection of one of the candidate employees. At step 716, the method 700 may include sending, to the selected candidate employee, an offer to fulfill the target available shift. At step 718, the method 700 may include receiving, from the selected candidate employee, an indication of whether they agree to fulfill the target available shift.

In some embodiments, the methods and processes described herein may be tied to a computing system of one or more computing devices. In particular, such methods and processes may be implemented as a computer-application program or service, an application-programming interface (API), a library, and/or other computer-program product.

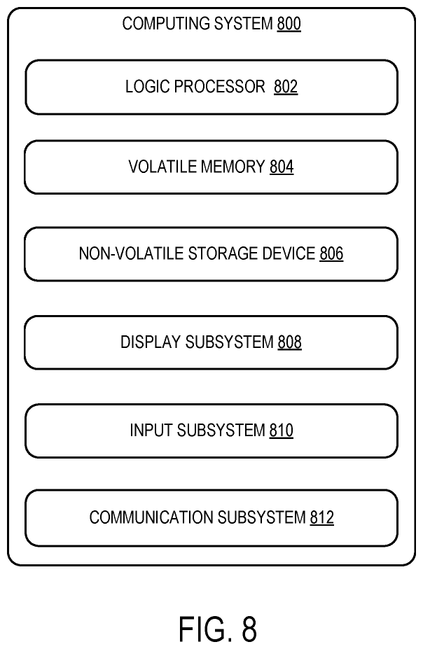

FIG. 8 schematically shows a non-limiting embodiment of a computing system 800 that can enact one or more of the methods and processes described above. Computing system 800 is shown in simplified form. Computing system 800 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 800 includes a logic processor 802 volatile memory 804, and a non-volatile storage device 806. Computing system 800 may optionally include a display subsystem 808, input subsystem 810, communication subsystem 812, and/or other components not shown in FIG. 8.

Logic processor 802 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 802 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 806 includes one or more physical devices configured to hold instructions executable by the logic processors to implement the methods and processes described herein. When such methods and processes are implemented, the state of non-volatile storage device 806 may be transformed—e.g., to hold different data.

Non-volatile storage device 806 may include physical devices that are removable and/or built-in. Non-volatile storage device 806 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 806 may include nonvolatile, dynamic, static, read/write, read-only, sequential-access, location-addressable, file-addressable, and/or content-addressable devices. It will be appreciated that non-volatile storage device 806 is configured to hold instructions even when power is cut to the non-volatile storage device 806.

Volatile memory 804 may include physical devices that include random access memory. Volatile memory 804 is typically utilized by logic processor 802 to temporarily store information during processing of software instructions. It will be appreciated that volatile memory 804 typically does not continue to store instructions when power is cut to the volatile memory 804.

Aspects of logic processor 802, volatile memory 804, and non-volatile storage device 806 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 800 typically implemented in software by a processor to perform a particular function using portions of volatile memory, which function involves transformative processing that specially configures the processor to perform the function. Thus, a module, program, or engine may be instantiated via logic processor 802 executing instructions held by non-volatile storage device 806, using portions of volatile memory 804. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 808 may be used to present a visual representation of data held by non-volatile storage device 806. The visual representation may take the form of a graphical user interface (GUI). As the herein described methods and processes change the data held by the non-volatile storage device, and thus transform the state of the non-volatile storage device, the state of display subsystem 808 may likewise be transformed to visually represent changes in the underlying data. Display subsystem 808 may include one or more display devices utilizing virtually any type of technology. Such display devices may be combined with logic processor 802, volatile memory 804, and/or non-volatile storage device 806 in a shared enclosure, or such display devices may be peripheral display devices.

When included, input subsystem 810 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 812 may be configured to communicatively couple various computing devices described herein with each other, and with other devices. Communication subsystem 812 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 800 to send and/or receive messages to and/or from other devices via a network such as the Internet.

The following paragraphs provide additional description of aspects of the present disclosure. One aspect provides a computerized staffing platform comprising a staffing server that includes a processor and associated memory. The processor may be configured to execute instructions using portions of the memory to store data indicating a plurality of available shifts from a plurality of third-party businesses, and store data indicating a plurality of employees of the computerized staffing platform who are registered to fulfill available shifts listed on the staffing server. The processor may be further configured to receive, from a particular business of the plurality of third-party businesses, a request to fulfill a target available shift, and determine, from the plurality of employees, one or more candidate employees for the target available shift. For each candidate employee, the processor may be further configured to compute a predicted labor burden associated with hiring the candidate employee for the target available shift. The predicted labor burden may account for whether the candidate employee has exceeded an income threshold after which a labor burden factor no longer applies. The predicted labor burden may be based on earned income data recorded for the candidate employee for one or more shifts fulfilled with at least one third-party business on the computerized staffing platform. The processor may be further configured to send, to the particular business, a list of the candidate employees, including an indication of the predicted labor burden for each candidate employee, and receive, from the particular business, a selection of one of the candidate employees. The processor may be further configured to send, to the selected candidate employee, an offer to fulfill the target available shift, and receive, from the selected candidate employee, an indication of whether they agree to fulfill the target available shift.

In this aspect, additionally or alternatively, the processor may be further configured to receive, from a particular employee of the plurality of employees, a query for available shifts, and determine, from the plurality of available shifts, one or more candidate shifts for the particular employee's query. The processor may be further configured to display an indication of an employee incentive for each candidate shift based upon the particular employee's predicted labor burden for the respective candidate shift.

In this aspect, additionally or alternatively, the labor burden factor may be at least one of a first tax rate and a second tax rate, and the predicted labor burden for the candidate employee may be computed at least in part by: estimating a first amount of gross income earned by the candidate employee for one or more shifts fulfilled with at least one third-party business on the computerized staffing platform in a plurality of regions; determining the first tax rate and a predetermined first earned income threshold above which the first tax rate does not apply; calculating an amount of first tax to be paid for the target available shift based on the first tax rate, a pay rate for the target available shift, and a duration of the target available shift; estimating a second amount of gross income earned by the candidate employee for one or more shifts fulfilled with at least one third-party business on the computerized staffing platform in a particular region of the plurality of regions in which the target candidate shift is located; determining the second tax rate associated with the particular region and a predetermined second earned income threshold above which the second tax rate does not apply; and calculating an amount of second tax to be paid for the target available shift based on the second tax rate, the pay rate for the target available shift, and the duration of the target available shift.

In this aspect, additionally or alternatively, the second tax rate for the particular region may be different from a second tax rate for at least one other region of the plurality of regions.

In this aspect, additionally or alternatively, the staffing server may store, in the data indicating a plurality of employees and employee information. The employee information may include, for each region of the plurality of regions, the amount of first tax and the amount of second tax that have been paid for each employee of the plurality of employees of the computerized staffing platform.

In this aspect, additionally or alternatively, when at least one of the first tax and the second tax does not apply, the computerized staffing platform may reduce the labor burden of the candidate employee.

In this aspect, additionally or alternatively, when the labor burden of the candidate employee is reduced, the computerized staffing platform may reduce the cost of the candidate employee selected by the particular business for the target available shift.

In this aspect, additionally or alternatively, the particular business may increase the pay rate of the candidate employee for the target available shift based on the reduced cost of the candidate employee to the particular business.

In this aspect, additionally or alternatively, the request by the particular third-party business to fulfill a target available shift may include filtering candidate employees for the target available shift based on whether at least one of the first tax and the second tax does not apply.

In this aspect, additionally or alternatively, if the target available shift remains unfulfilled for a predetermined amount of time, the particular third-party business may change the request to include an indication of an employee incentive based upon a condition under which at least one of the first tax and the second tax does not apply.

In this aspect, additionally or alternatively, the computerized staffing platform may be configured to compute a monetary reward based on the reduced labor burden and display the monetary reward to the candidate employee.

In this aspect, additionally or alternatively, the monetary reward may be an increased pay rate. In this aspect, additionally or alternatively, the monetary reward may be a one-time bonus.

Another aspect provides a method for a computerized staffing platform. The method may comprise storing data indicating a plurality of available shifts from a plurality of third-party businesses, and storing data indicating a plurality of employees of the computerized staffing platform who are registered to fulfill available shifts listed on the server. The method may further comprise receiving, from a particular business of the plurality of third-party businesses, a request to fulfill a target available shift, and determining, from the plurality of employees, one or more candidate employees for the target available shift. The method may further comprise, for each candidate employee, computing a predicted labor burden associated with hiring the candidate employee for the target available shift. The predicted labor burden may account for whether the candidate employee has exceeded an income threshold after which a labor burden factor no longer applies. The predicted labor burden may be based on earned income data recorded for the candidate employee for one or more shifts fulfilled with at least one third-party business on the computerized staffing platform. The method may further comprise sending, to the particular business, a list of the candidate employees, including an indication of the predicted labor burden for each candidate employee, and receiving, from the particular business, a selection of one of the displayed candidate employees. The method may further comprise sending, to the selected candidate employee, an offer to fulfill the target available shift, and receiving, from the selected candidate employee, an indication of whether they agree to fulfill the target available shift.

In this aspect, additionally or alternatively, the method may further comprise receiving, from a particular employee of the plurality of employees, a query for available shifts, and determining, from the plurality of available shifts, one or more candidate shifts for the particular employee's query. The method may further comprise displaying an indication of an employee incentive for each candidate shift based upon the particular employee's predicted labor burden for the respective candidate shift.

In this aspect, additionally or alternatively, the method may further comprise estimating a first amount of gross income earned by the candidate employee for one or more shifts fulfilled with at least one third-party business on the computerized staffing platform in a plurality of regions, determining the first tax rate and a predetermined first earned income threshold above which the first tax rate does not apply, and calculating an amount of first tax to be paid for the target available shift based on the first tax rate, a pay rate for the target available shift, and a duration of the target available shift. The method may further comprise estimating a second amount of gross income earned by the candidate employee for one or more shifts fulfilled with at least one third-party business on the computerized staffing platform in a particular region of the plurality of regions in which the target candidate shift is located, determining the second tax rate associated with the particular region and a predetermined second earned income threshold above which the second tax rate does not apply, and calculating an amount of second tax to be paid for the target available shift based on the second tax rate, the pay rate for the target available shift, and the duration of the target available shift.

In this aspect, additionally or alternatively, the second tax rate for the particular region may be different from a second tax rate for at least one other region of the plurality of regions.

In this aspect, additionally or alternatively, the method may further comprise storing employee information in the data indicating a plurality of employees, and including, in the employee information, for each region of the plurality of regions, the amount of first tax and the amount of second tax that have been paid for each employee of the plurality of employees of the computerized staffing platform.

In this aspect, additionally or alternatively, the method may further comprise, when at least one of the first tax and the second tax does not apply, reducing the labor burden of the candidate employee.

In this aspect, additionally or alternatively, the method may further comprise, when the labor burden of the candidate employee is reduced, reducing the cost of the candidate employee selected by the particular business for the target available shift.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computerized staffing platform, comprising:
a staffing server including a processor and associated memory, the processor being configured to execute instructions using portions of the memory to:
store data indicating a plurality of available shifts from a plurality of third-party businesses, and store data indicating a plurality of employees of the computerized staffing platform who are registered to fulfill available shifts listed on the staffing server;
receive, from a particular business of the plurality of third-party businesses, a request to fulfill a target available shift;
determine, from the plurality of employees, one or more candidate employees for the target available shift;
for each candidate employee, compute a predicted labor burden associated with hiring the candidate employee for the target available shift, the predicted labor burden accounting for whether the candidate employee has exceeded an income threshold after which a labor burden factor no longer applies, the predicted labor burden being based on earned income data recorded for the candidate employee for one or more shifts fulfilled with at least one third-party business on the computerized staffing platform;
send, to the particular business, a list of the candidate employees, including an indication of the predicted labor burden for each candidate employee;
receive, from the particular business, a selection of one of the candidate employees;
send, to the selected candidate employee, an offer to fulfill the target available shift; and
receive, from the selected candidate employee, an indication of whether they agree to fulfill the target available shift.

2. The computerized staffing platform of claim 1, wherein
the processor is further configured to execute instructions using portions of the memory to:
receive, from a particular employee of the plurality of employees, a query for available shifts;
determine, from the plurality of available shifts, one or more candidate shifts for the particular employee's query; and
display an indication of an employee incentive for each candidate shift based upon the particular employee's predicted labor burden for the respective candidate shift.

3. The computerized staffing platform of claim 1, wherein
the labor burden factor is at least one of a first tax rate and a second tax rate, and
the predicted labor burden for the candidate employee is computed at least in part by:
estimating a first amount of gross income earned by the candidate employee for one or more shifts fulfilled with at least one third-party business on the computerized staffing platform in a plurality of regions;
determining the first tax rate and a predetermined first earned income threshold above which the first tax rate does not apply;
calculating an amount of first tax to be paid for the target available shift based on the first tax rate, a pay rate for the target available shift, and a duration of the target available shift;
estimating a second amount of gross income earned by the candidate employee for one or more shifts fulfilled with at least one third-party business on the computerized staffing platform in a particular region of the plurality of regions in which the target candidate shift is located;
determining the second tax rate associated with the particular region and a predetermined second earned income threshold above which the second tax rate does not apply; and
calculating an amount of second tax to be paid for the target available shift based on the second tax rate, the pay rate for the target available shift, and the duration of the target available shift.

4. The computerized staffing platform of claim 3, wherein
the second tax rate for the particular region is different from a second tax rate for at least one other region of the plurality of regions.

5. The computerized staffing platform of claim 3, wherein
the staffing server further stores, in the data indicating a plurality of employees and employee information, and
the employee information includes, for each region of the plurality of regions, the amount of first tax and the amount of second tax that have been paid for each employee of the plurality of employees of the computerized staffing platform.

6. The computerized staffing platform of claim 3, wherein
when at least one of the first tax and the second tax does not apply, the computerized staffing platform reduces the labor burden of the candidate employee.

7. The computerized staffing platform of claim 6, wherein
when the labor burden of the candidate employee is reduced, the computerized staffing platform reduces the cost of the candidate employee selected by the particular business for the target available shift.

8. The computerized staffing platform of claim 7, wherein
the particular business increases the pay rate of the candidate employee for the target available shift based on the reduced cost of the candidate employee to the particular business.

9. The computerized staffing platform of claim 7, wherein
the request by the particular third-party business to fulfill a target available shift includes filtering candidate employees for the target available shift based on whether at least one of the first tax and the second tax does not apply.

10. The computerized staffing platform of claim 7, wherein
if the target available shift remains unfulfilled for a predetermined amount of time, the particular third-party business changes the request to include an indication of an employee incentive based upon a condition under which at least one of the first tax and the second tax does not apply.

11. The computerized staffing platform of claim 6, wherein
the computerized staffing platform is configured to compute a monetary reward based on the reduced labor burden and display the monetary reward to the candidate employee.

12. The computerized staffing platform of claim 11, wherein
the monetary reward is an increased pay rate.

13. The computerized staffing platform of claim 11, wherein
the monetary reward is a one-time bonus.

14. A method for a computerized staffing platform, the method comprising:
storing data indicating a plurality of available shifts from a plurality of third-party businesses;
storing data indicating a plurality of employees of the computerized staffing platform who are registered to fulfill available shifts listed on the server;
receiving, from a particular business of the plurality of third-party businesses, a request to fulfill a target available shift;
determining, from the plurality of employees, one or more candidate employees for the target available shift;
for each candidate employee, computing a predicted labor burden associated with hiring the candidate employee for the target available shift, the predicted labor burden accounting for whether the candidate employee has exceeded an income threshold after which a labor burden factor no longer applies, the predicted labor burden being based on earned income data recorded for the candidate employee for one or more shifts fulfilled with at least one third-party business on the computerized staffing platform;
sending, to the particular business, a list of the candidate employees, including an indication of the predicted labor burden for each candidate employee;
receiving, from the particular business, a selection of one of the displayed candidate employees;
sending, to the selected candidate employee, an offer to fulfill the target available shift; and
receiving, from the selected candidate employee, an indication of whether they agree to fulfill the target available shift.

15. The method of claim 14, the method further comprising:
receiving, from a particular employee of the plurality of employees, a query for available shifts;
determining, from the plurality of available shifts, one or more candidate shifts for the particular employee's query; and
displaying an indication of an employee incentive for each candidate shift based upon the particular employee's predicted labor burden for the respective candidate shift.

16. The method of claim 14, the method further comprising:
estimating a first amount of gross income earned by the candidate employee for one or more shifts fulfilled with at least one third-party business on the computerized staffing platform in a plurality of regions;
determining the first tax rate and a predetermined first earned income threshold above which the first tax rate does not apply;
calculating an amount of first tax to be paid for the target available shift based on the first tax rate, a pay rate for the target available shift, and a duration of the target available shift;
estimating a second amount of gross income earned by the candidate employee for one or more shifts fulfilled with at least one third-party business on the computerized staffing platform in a particular region of the plurality of regions in which the target candidate shift is located;
determining the second tax rate associated with the particular region and a predetermined second earned income threshold above which the second tax rate does not apply; and
calculating an amount of second tax to be paid for the target available shift based on the second tax rate, the pay rate for the target available shift, and the duration of the target available shift.

17. The method of claim 16, wherein
the second tax rate for the particular region is different from a second tax rate for at least one other region of the plurality of regions.

18. The method of claim 16, the method further comprising:
storing employee information in the data indicating a plurality of employees; and
including, in the employee information, for each region of the plurality of regions, the amount of first tax and the amount of second tax that have been paid for each employee of the plurality of employees of the computerized staffing platform.

19. The method of claim 16, the method further comprising:
when at least one of the first tax and the second tax does not apply, reducing the labor burden of the candidate employee.

20. The computerized staffing platform of claim 19, the method further comprising:
when the labor burden of the candidate employee is reduced, reducing the cost of the candidate employee selected by the particular business for the target available shift.
